(19) United States
(12) Patent Application Publication
(10) Pub. No.: US 2023/0272189 A1
(43) Pub. Date: Aug. 31, 2023

(54) POLYARYLENE SULFIDE RESIN COMPOSITION, AND METHOD FOR IMPROVING MOLDABILITY OF POLYARYLENE SULFIDE RESIN

(71) Applicant: LG CHEM, LTD., Seoul (KR)

(72) Inventors: Tadashi TAKEDA, Tokyo (JP); Eon Seok LEE, Daejeon (KR)

(21) Appl. No.: 18/019,704

(22) PCT Filed: Oct. 5, 2021
(86) PCT No.: PCT/KR2021/013612

§ 371 Date: Feb. 3, 2023

(30) Foreign Application Priority Data
Oct. 12, 2020 (JP) 2020-171805

(51) Int. Cl. C08K 5/5398; C08G 75/0209

(52) U.S. Cl. CPC C08K 5/5398; C08G 75/0209

(57) ABSTRACT

The present disclosure is directed to providing a polyarylene sulfide resin composition having excellent mechanical properties, surface appearance and heat resistance as well as excellent moldability, and a method for enhancing moldability of a polyarylene sulfide resin without deterioration of mechanical properties such as strength, impact, and heat resistance, as well as surface appearance. The goal of the present disclosure is accomplished by a polyarylene sulfide resin composition including a polyarylene sulfide and a zinc dialkyldithiophosphate.

The present application is a National Phase entry pursuant to 35 U.S.C. § 371 of International Application No. PCT/KR2021/013612 filed on Oct. 5, 2021 and claims priority to and the benefit of Japanese Patent Application No. 2020-171805, filed with the Japan Patent Office on Oct. 12, 2020, the entire contents of which are incorporated herein by reference.

### FIELD

The present disclosure relates to a polyarylene sulfide resin composition, and a method for enhancing moldability of a polyarylene sulfide resin.

### BACKGROUND

A polyarylene sulfide is an engineering plastic having excellent heat resistance, rigidity, dimensional stability, flame retardancy and the like, and is widely used as a material replacing metal materials in fields of electrical and electronics, machinery, automobiles and the like. For example, a polyarylene sulfide is used as a material of a water tank for cooling an engine in an engine room. Accordingly, materials used for these applications are required to have an excellent surface appearance as well as having excellent heat resistance and mechanical properties. A representative polyarylene sulfide resin may include a polyphenylene sulfide resin.

In addition, a polyarylene sulfide is used as an alternative material for metals processed using a casting method by die casting such as aluminum and zinc, and high moldability is also required. However, using additives in the polyarylene sulfide to enhance moldability has a problem in that properties other than moldability such as mechanical properties and heat resistance deteriorate.

Using various additives to a polyarylene sulfide resin is known. For example, the publication of Japanese Patent Application Laid-Open No. 2016-34999 discloses a polyarylene sulfide resin composition to which composite particles of a conductive filler, and an inorganic lubricant, are added in order to provide uniform conductivity.

However, additives having effects of enhancing moldability, and not declining or enhancing mechanical properties such as impact, and heat resistance have not been known so far. Accordingly, there has been a problem of insufficient flexibility when injection molding a polyarylene sulfide resin in the art.

### Patent Documents

(Patent Document 1) Publication of Japanese Patent Application Laid-Open No. 2016-34999

### SUMMARY

Accordingly, a polyarylene sulfide resin composition having excellent moldability compared to existing polyarylene sulfide resins, and having excellent surface appearance and heat resistance without declining mechanical properties such as strength and impact, and a method for enhancing moldability of a polyarylene sulfide resin have been required.

The present disclosure has been made in view of the above, and is directed to providing a polyarylene sulfide resin composition having excellent mechanical properties, surface appearance and heat resistance as well as having excellent moldability, and a method for enhancing moldability of a polyarylene sulfide resin without deteriorating mechanical properties such as strength, impact, and heat resistance, as well as surface appearance.

As a result of intensive studies on the above-described problems, the inventors of the present disclosure have unexpectedly discovered that, by using a zinc dialkyldithiophosphate as an additive, moldability of a polyarylene sulfide resin is enhanced, and mechanical properties such as strength, impact, and heat resistance, as well as surface appearance, are also superior, and have come to the present disclosure.

The goal of the present disclosure is accomplished by a polyarylene sulfide resin composition including a polyarylene sulfide and a zinc dialkyldithiophosphate.

The number of carbon atoms of the alkyl group of the zinc dialkyldithiophosphate is preferably from 5 to 20.

The zinc dialkyldithiophosphate is preferably included in an amount of greater than or equal to 0.001 parts by mass and less than or equal to 20 parts by mass with respect to 100 parts by mass of the polyarylene sulfide resin.

The polyarylene sulfide is preferably polyphenylene sulfide.

The polyarylene sulfide is preferably included in an amount of greater than or equal to 40% by mass and less than or equal to 99% by mass of the polyarylene sulfide resin composition.

The present disclosure also relates to, as a method for enhancing moldability of a polyarylene sulfide resin, and a method of adding a zinc dialkyldithiophosphate to the polyarylene sulfide resin.

In the method, the number of carbon atoms of the alkyl group of the zinc dialkyldithiophosphate is preferably from 5 to 20.

In the method, the zinc dialkyldithiophosphate is preferably added in an amount of greater than or equal to 0.001 parts by mass and less than or equal to 20 parts by mass with respect to 100 parts by mass of the polyarylene sulfide resin.

In the method, the polyarylene sulfide is preferably polyphenylene sulfide.

According to the present disclosure, moldability of a polyarylene sulfide resin can be enhanced by using a zinc dialkyldithiophosphate. In addition, by having excellent mechanical properties such as strength, impact, and heat resistance, as well as excellent moldability, the polyarylene sulfide resin can be used under a high temperature environment such as an automotive engine as well. In addition, the surface appearance is excellent as well, and therefore, the polyarylene sulfide resin of the present disclosure can be used for directly visible applications as well as used as an inner structure.

In addition, compared to existing polyarylene sulfide resin compositions, mechanical properties and surface appearance do not deteriorate even when adding additives in the present disclosure. Accordingly, the present disclosure has advantages of not only enhancing moldability, but also having equal or enhanced other properties compared to cases of adding no additives.

### DETAILED DESCRIPTION

Hereinafter, the present disclosure will be described in detail. However, it is not meant to limit the present disclosure to specific embodiments, and various modifications may be added within the scope of technical ideas of the present disclosure.

A polyarylene sulfide resin composition of the present disclosure includes a polyarylene sulfide and a zinc dialkyldithiophosphate as essential constituents.

### Polyarylene Sulfide

A polyarylene sulfide includes a structure in which an aromatic ring and a sulfur atom bond as a repeating unit. More specifically, a polyarylene sulfide preferably employs a p-phenylene sulfide unit as a basic repeating unit, but may also include a repeating unit such as an m-phenylene sulfide unit, an o-phenylene sulfide unit, a p,p′-diphenylene ketone sulfide unit, a p,p′-diphenylene sulfone sulfide unit, a p,p′-biphenylene sulfide unit, a p,p′-diphenylene ether sulfide unit, a p,p′-diphenylene methylene sulfide unit, a p,p′-diphenylene cumenyl sulfide unit and various naphthylene sulfide units.

The polyarylene sulfide is preferably polyphenylene sulfide, and may particularly be polyphenylene sulfide including a repeating unit of the following Chemical Formula 1.

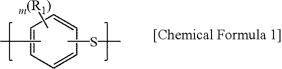

In Chemical Formula 1,
R₁s are each independently selected from the group consisting of a hydrogen atom, an alkyl group having 1 to 6 carbon atoms, an alkoxy group having 1 to 6 carbon atoms, a nitro group, an amino group and a phenyl group, and
m is an integer of 0 to 4.

Examples of the alkyl group having 1 to 6 carbon atoms may include a methyl group, an ethyl group, a propyl group, a butyl group, a pentyl group, a hexyl group and the like, and examples of the alkoxy group having 1 to 6 carbon atoms may include a methoxy group, an ethoxy group, a propoxy group, a butoxy group, a pentyloxy group, a hexyloxy group and the like, however, the alkyl group and the alkoxy group are not limited thereto. The alkyl group having 1 to 6 carbon atoms and the alkoxy group having 1 to 6 carbon atoms may be linear or branched. In addition, the alkyl group having 1 to 6 carbon atoms, the alkoxy group having 1 to 6 carbon atoms, the nitro group, the amino group and the phenyl group of R₁ may be substituted with a substituent selected from the group consisting of halogen, a hydroxyl group, an alkyl group, an alkoxy group and an aryl group.

In Chemical Formula 1, the sulfur atom in the aromatic ring may bond to any position of ortho, meta and para, but preferably bonds to a para position in terms of exhibiting more superior heat resistance and crystallinity.

The polyarylene sulfide has a number average molecular weight (Mn) of 1,000 to 1,000,000, and preferably 1,000 to 100,000, 5,000 to 100,000, 10,000 to 500,000 or 10,000 to 50,000. The number average molecular weight of the polyarylene sulfide may be measured by high temperature GPC, and means a value converted with standard polystyrene. As the molecular weight of the polystyrene standard, 9 types of 2,000/10,000/30,000/70,000/200,000/700,000/2,000,000/4,000,000/ 10,000,000 may be used.

A melt flow rate (MFR) of the polyarylene sulfide may be from 10 g/10 minutes to 10,000 g/10 minutes, and preferably from 10 g/10 minutes to 1,000 g/10 minutes when measured under a pressure of 2.16 kg at 315° C. The polyarylene sulfide resin having a melt flow rate in the above-mentioned range may have superior processability and flexibility.

In addition, the polyarylene sulfide may have a melting temperature (Tm) of 210° C. to 350° C. and a crystallization temperature (Tc) of 190° C. to 330° C., and preferably, Tm may be from 220° C. to 330° C. and Tc may be from 200° C. to 310° C. The melting temperature and the crystallization temperature of the polyarylene sulfide may be measured using differential scanning calorimetry (DSC).

The polyarylene sulfide may be a linear polyarylene sulfide resin or an oxidation crosslinked polyarylene sulfide resin, however, using a linear polyarylene sulfide resin is preferred.

As the polyarylene sulfide, a polyarylene sulfide prepared using a method of, for example, polycondensation reacting a common dehalogenoaromatic compound and a sulfur source in an organic polar solvent may be used.

The polyarylene sulfide is included in an amount of greater than or equal to 40% by mass and less than or equal to 99% by mass, preferably greater than or equal to 45% by mass and less than or equal to 95% by mass, more preferably greater than or equal to 50% by mass and less than or equal to 90% by mass, and most preferably greater than or equal to 55% by mass and less than or equal to 80% by mass of the polyarylene sulfide resin composition.

### Zinc Dialkyldithiophosphate

A zinc dialkyldithiophosphate is a compound represented by the following Chemical Formula 2.

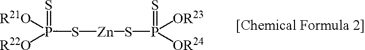

In Chemical Formula 2,

R²¹, R²², R²³ and R²⁴ are each independently an alkyl group having 5 to 20 carbon atoms.

In other words, the number of carbon atoms of the alkyl group of the zinc dialkyldithiophosphate is preferably from 5 to 20, more preferably from 8 to 20, and most preferably from 10 to 18.

Examples of the alkyl group having 5 to 20 carbon atoms may include a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group and the like, but are not limited thereto. The alkyl group having 5 to 20 carbon atoms may be linear or branched.

The zinc dialkyldithiophosphate is included in an amount of greater than or equal to 0.001 parts by mass and less than or equal to 20 parts by mass, preferably greater than or equal to 0.01 parts by mass and less than or equal to 10 parts by mass, more preferably greater than or equal to 0.1 parts by mass and less than or equal to 5 parts by mass, and most preferably greater than or equal to 0.2 parts by mass and less than or equal to 2 parts by mass, with respect to 100 parts by mass of the polyarylene sulfide resin.

### Other Components

The polyarylene sulfide resin composition of the present disclosure may further include resins other than the polyarylene sulfide as the resin. For example, the polyarylene sulfide resin composition may include one or more types of a polyolefin resin, a polycarbonate resin, a polyamide resin, a polyester resin, a polyacetal resin, a modified polyphenylene ether resin, a polyethylene terephthalate resin, a polybutylene terephthalate resin, a polyethylene naphthalate resin, a polyarylate resin, a polyethersulfone resin, a polyetherketone resin, a polythioetherketone resin, a polyetheretherketone resin, a polysulfone resin, a polyimide resin, a polyamideimide resin, a polyetherimide resin, a polyarylene resin, a polybenzimidazole resin, a polymethylpentene resin, a polycyclohexylene-dimethylene-terephthalate resin, a polystyrene resin, a polyphenylene oxide resin, a styrene-based resin, a polymethacrylic resin, a polyacrylic resin, a polydifluoroethylene resin, a polytetrafluoroethylene resin, a polyketone resin, an ABS resin, a phenol resin, an urethane resin, a nylon-based resin, a silicone resin and a thermoplastic resin such as a thermoplastic elastomer.

In addition, the polyarylene sulfide resin composition of the present disclosure may further include, in order to improve properties according to the use of the resin composition, one or more types of additives such as a coupling agent, a fiber material, a filler, an impact-resistance providing agent, a reinforcing agent, a release agent, a coloring agent, an antioxidant, a heat stabilizer, an ultraviolet stabilizer, an ultraviolet absorber, a foaming agent, a flame retardant, a flame retardant aid, a rust inhibitor, a nucleating agent, a plasticizer, a pigment, a dye, an antistatic agent, and a lubricant other than the zinc dialkyldithiophosphate.

The coupling agent is not particularly limited, and silane-based or titanium-based coupling agents may be used. More specifically, epoxy group-containing alkoxysilane compounds such as γ-glycidoxypropyltrimethoxysilane, γ-glycidoxypropyltriethoxysilane and β-(3,4-epoxycyclohexyl)ethyltrimethoxysilane; isocyanato group-containing alkoxysilane compounds such as γ-isocyanatopropyltrimethoxysilane, γ-isocyanatopropyltriethoxysilane, γ-isocyanatopropylmethyldimethoxysilane, γ-isocyanatopropylmethyldiethoxysilane, γ-isocyanatopropylethyldimethoxysilane, γ-isocyanatopropylethyldiethoxysilane and γ-isocyanatopropyltrichlorosilane; amino group-containing alkoxysilane compounds such as γ-(2-aminoethyl) aminopropylmethyldimethoxysilane, γ-(2-aminoethyl)aminopropyltrimethoxysilane and γ-aminopropyltrimethoxysilane; hydroxy group-containing alkoxysilane compounds such as γ-hydroxypropyltrimethoxysilane and γ-hydroxypropyltriethoxysilane, and the like may be included, and any one type, or a mixture of two or more types thereof may be used.

The coupling agent is included in an amount of 10% by mass or less, and preferably 0.01% by mass to 5% by mass, of the polyarylene sulfide resin composition. Including the coupling agent in the above-mentioned range may provide excellent moldability by increasing viscosity, as well as improving mechanical strength of the polyarylene sulfide resin composition.

The fiber material is not particularly limited, however, fiber-shaped materials having an average fiber diameter of 1 µm to 50 µm and an average fiber length of 0.5 mm to 25 mm may be used. The fiber material may be an inorganic fiber material or an organic fiber material. Examples of the inorganic fiber material may include glass fiber such as chopped strand, milled fiber and roving, carbon fiber such as PAN-based carbon fiber and pitch-based carbon fiber, graphitized fiber, whisker materials such as silicon nitride whisker, basic magnesium sulfate whisker, barium titanate whisker, potassium titanate whisker, silicon carbide whisker, boron whisker, aluminum borate whisker and zinc oxide whisker, metal fiber such as stainless fiber, mineral-based fiber such as wollastonite, asbestos, sepiolite, slag fiber, zirconia, rock wool, ceramic, xonotlite, elastadite and gypsum. Examples of the organic fiber material may include wholly aromatic polyamide fiber, phenol resin fiber, wholly aromatic polyester fiber and the like, and any one type, or a mixture of two or more types thereof may be used. Preferably, the fiber material is an inorganic fiber material, and glass fiber is particularly preferred.

When using glass fiber as the fiber material, alkali-free glass (E glass) or alkali-containing glass (C glass) containing SiO₂ in 45% by weight to 75% by weight is preferred as the glass fiber.

The fiber material may or may not be surface treated, but is preferably surface treated. A surface treatment agent used for treating a surface of the fiber material is not particularly limited, and examples thereof may include coupling agents such as isocyanate-based compounds, organo-silane-based compounds, organo-titanate-based compounds, organo-borane-based compounds and epoxy compounds. The surface treatment agent for the fiber material may be preferably used in, for example, 0.1% by mass to 5% by mass, with respect to the mass of the fiber material. In addition, the attached amount of the surface treatment agent of the fiber material may be calculated by, for example, measuring a weight of the fiber material sufficiently dried, heat treating the fiber material at 625° C., then measuring a weight of the fiber material again, and dividing the weight loss of the fiber material due to the heat treatment by the weight of the fiber material before the heat treatment.

The fiber material is included in an amount of greater than or equal to 5% by mass and less than or equal to 80% by mass, preferably greater than or equal to 10% by mass and less than or equal to 70% by mass, and more preferably greater than or equal to 20% by mass and less than or equal to 60% by mass, of the polyarylene sulfide resin composition.

The filler is not particularly limited, and metal materials such as nickel, copper, gold, silver, aluminum, zinc, tin, lead, chromium, platinum, palladium, tungsten and molybdenum, alloys or blends thereof; or carbon materials such as artificial graphite, natural graphite, glassy carbon, carbon black, acetylene black, ketjen black and carbon nanotubes may be used, and any one type, or a mixture of two or more types thereof may be used. In addition, the filler may be surface treated by a compound including a silanol group or the like in order to increase miscibility with the polyarylene sulfide.

The filler is included in an amount of 10% by mass or less, and preferably 5% by mass or less, of the polyarylene sulfide resin composition. When included in the above-mentioned range, mechanical strength of the polyarylene sulfide resin composition may be improved without reducing moldability.

The impact-resistance providing agent is not particularly limited, and thermoplastic elastomers obtained by copolymerizing α-olefins and vinyl polymerizable compounds, and the like, may be used, and one type or a mixture of two or more types may be used. Examples of the α-olefins may include α-olefins having 2 to 8 carbon atoms such as ethylene, propylene and 1-butene, and examples of the vinyl polymerizable compound may include α,β-unsaturated carboxylic acids such as (meth)acrylic acid and (meth)acrylic acid ester, and alkyl esters thereof; α,β-unsaturated dicarboxylic acids such as maleic acid, fumaric acid and itaconic acid, and derivatives thereof; glycidyl (meth)acrylate, and the like.

The impact-resistance providing agent is included in an amount of 20% by mass or less, and preferably 5% by mass to 10% by mass, of the polyarylene sulfide resin composition. When included in the above-mentioned range, excellent moldability and releasability may be obtained together with excellent impact resistance and tensile strength.

The reinforcing agent is not particularly limited, and silica, alumina, glass beads, boron nitride, talc, silicate, silicon chloride, silicon carbide, metal oxide, carbonate, sulfate and the like may be used, and any one type, or a mixture of two or more types thereof may be used.

The reinforcing agent is included in an amount of 10% by mass or less, and preferably 1% by mass to 7% by mass, of the polyarylene sulfide resin composition. When included in the above-mentioned range, strength, rigidity, heat resistance, dimensional stability and the like of the polyarylene sulfide resin composition may be enhanced.

The antioxidant is not particularly limited, and, for example, hindered phenol-based antioxidants, hindered amine-based antioxidants, sulfur-containing antioxidants and phosphorous-containing antioxidants may be used, and particularly, hindered phenol-based antioxidants are preferred.

The antioxidant is included in an amount of 10% by mass or less, and preferably 5% by mass or less, of the polyarylene sulfide resin composition.

### Preparation Method

A method for preparing the polyarylene sulfide resin composition of the present disclosure is not particularly limited, and the polyarylene sulfide resin composition may be prepared using a method of supplying a mixture of raw materials to a common known melt mixer such as a monoaxial or biaxial extruder, a Banbury mixer, a kneader or a mixing roll, then heating the mixture to a temperature of 280° C. to 380° C. and kneading, or a method of mixing using various mixers such as a dissolver or a homogenizer. In addition, the mixing order of raw materials is not particularly limited, and any method may be used such as a method of mixing all raw materials and then melt-kneading the mixture using the above-described method, a method of mixing some of raw materials and then melt-kneading the mixture using the above-described method, and mixing the remaining raw materials and then melt-kneading the mixture, or a method of mixing some of raw materials and then, while melt-kneading the mixture using a monoaxial or biaxial extruder, mixing the remaining raw materials using a side feeder. In addition, as for the additive components used in small amounts, these may be added before molding after kneading other components using the above-described method or the like and pelleting the result.

The present disclosure also relates to, as a method for enhancing moldability of a polyarylene sulfide resin, a method of adding a zinc dialkyldithiophosphate to the polyarylene sulfide resin.

In the method of the present disclosure, moldability may be enhanced by adding a zinc dialkyldithiophosphate to the polyarylene sulfide resin composition. In addition, mechanical properties and heat resistance, which normally deteriorate as moldability is enhanced, do not deteriorate. On the contrary, mechanical properties and heat resistance may be enhanced by adding a zinc dialkyldithiophosphate.

The polyarylene sulfide resin composition of the present disclosure may be made into a molded article using, although not limited thereto, known molding methods such as injection molding, extrusion molding, compressing molding, blow molding, injection compression molding and transfer molding, and used for various applications.

Hereinafter, the present disclosure will be described more specifically using examples and comparative examples, however, the scope of the present disclosure is not limited to the examples.

### EXAMPLES

### Preparation of Polyarylene Sulfide Resin Composition

### Example

With respect to 59.3 parts by mass of polyphenylene sulfide (manufactured by Zhejiang NHU Co., Ltd., trade name: 1150, linear-type), 0.2 parts by mass of an antioxidant (manufactured by BASF Corporation, trade name: Irganox 1098), 0.3 parts by mass of a coupling agent (manufactured by Momentive Inc., trade name: A-187) and 0.2 parts by mass of a zinc dialkyldithiophosphate (manufactured by ADEKA Corporation, trade name: Z-112) were thoroughly mixed. After that, 40 parts by mass of glass fiber (manufactured by Nitto Boseki Co., Ltd., trade name: CS3J-256, average fiber diameter 10 µm, average fiber length 3 mm, aminosilane treated) was added thereto, and the result was melt-kneaded at 310° C. using a biaxial extruder to prepare a polyarylene sulfide resin composition. The obtained strand was cut using pelletizer to obtain pellets.

### Comparative Example 1

Polyarylene sulfide resin pellets were obtained in the same manner as in Example except that 59.5 parts by mass of polyphenylene sulfide was mixed instead of adding the zinc dialkyldithiophosphate.

### Comparative Example 2

Polyarylene sulfide resin pellets were obtained in the same manner as in Example except that 0.2 parts by mass of long-chain fatty acid ester (manufactured by Clariant AG, trade name: LICOWAX OP) was mixed instead of adding the zinc dialkyldithiophosphate.

Mixing prescriptions of the polyarylene sulfide resin compositions prepared in Example and Comparative Examples 1 and 2 are shown in the following Table 1.

TABLE 1

Mixing Prescription of Polyarylene Sulfide Resin Composition (Unit: Parts by Mass)

| | Example | Comp. Ex. 1 | Comp. Ex. 2 |
|---|---|---|---|
| Polyphenylene Sulfide | 59.3 | 59.5 | 59.3 |
| Glass Fiber | 40 | 40 | 40 |
| Antioxidant | 0.2 | 0.2 | 0.2 |
| Coupling Agent | 0.3 | 0.3 | 0.3 |
| Zinc Dialkyldithiophosphate | 0.2 | - | - |
| Long-Chain Fatty Acid Ester | - | - | 0.2 |

### Evaluation

The following properties were evaluated using the pellets obtained in Example and Comparative Examples 1 and 2.

### Charpy Impact Strength

The pellets obtained in Example and Comparative Examples 1 and 2 were injection molded using an injection molding machine, and impact strength specimens in accordance with the ISO 180 were prepared. Using the impact strength specimens obtained as above, Charpy impact strength (kJ/m²) was measured at 23° C. in accordance with the ISO 180.

### Tensile Strength and Elongation at Break

The pellets obtained in Example and Comparative Examples 1 and 2 were injection molded using an injection molding machine, and tensile specimens in accordance with the ISO 527 were prepared. Using the tensile specimens obtained as above, tensile strength (MPa) and elongation at break (%) were measured at a test rate of 5 mm/minute in accordance with the ISO 527.

### Bending Strength and Bending Modulus

The pellets obtained in Example and Comparative Examples 1 and 2 were injection molded using an injection molding machine, and bending specimens in accordance with the ISO 178 were prepared. Using the specimens for bending testing obtained as above, bending strength (MPa) and bending modulus (MPa) were measured at a test rate of 2 mm/minute in accordance with the ISO 178.

### Thermal-Deformation Temperature

The pellets obtained in Example and Comparative Examples 1 and 2 were injection molded using an injection molding machine, and load-deformation specimens in accordance with the ISO 75 were prepared. Using the specimens for load-deformation testing obtained as above, thermal-deformation temperature (load-deformation temperature) was measured with a load of 1.8 MPa flatwise in accordance with the ISO 75.

### Crystallization Temperature

Dried samples of the obtained pellets of Example and Comparative Examples 1 and 2 were cut in small amounts, and the temperature was raised to 300° C. at 20° C./minute and maintained for 10 minutes to completely melt crystals of the polyarylene sulfide resin. After that, the temperature was lowered at 20° C./minute, and an exothermic peak temperature of the crystallization was employed as a crystallization temperature.

### Moldability

An injection pressure when the obtained pellets of Example and Comparative Examples 1 and 2 were injection molded at a molding temperature of 310° C. using an injection molding machine was measured.

### Surface Appearance

The obtained pellets of Example and Comparative Examples 1 and 2 were injection molded with an ISO dumbbell for tensile testing at a molding temperature of 310° C., a die temperature of 150° C. and a constant rate of 50 mm/second using an injection molding machine, and the dumbbell appearances were visually compared.

The measurement results are shown in the following Table 2.

TABLE 2

Properties of Polyarylene Sulfide Resin

| | | | |
|---|---|---|---|
| Properties | Ex. | Com. Ex. 1 | Comp. Ex. 2 |
| Charpy Impact Strength (kJ/M²) | 101 | 94 | 87 |
| Tensile Strength (MPa) | 214 | 208 | 206 |
| Elongation at Break (%) | 0.6 | 0.7 | 0.6 |
| Bending Modulus (MPa) | 13500 | 13340 | 12451 |
| Bending Strength (MPa) | 294 | 287 | 271 |
| Thermal-Deformation Temperature (°C) | > 260 | > 260 | > 260 |
| Crystallization Temperature (°C) | 214 | 202 | 202 |
| Injection Pressure (bar) | 645 | 748 | 748 |
| Surface Appearance | ◯ | × | Δ |

From the results of Table 2, it was seen that the polyarylene sulfide resin of Example using a zinc dialkyldithiophosphate had excellent moldability due to a significantly decreased injection pressure, and, in addition thereto, was capable enhancing mechanical properties such as Charpy impact strength, tensile strength, elongation at break, bending strength and bending modulus. In addition, the thermal-deformation temperature did not decrease, and the surface appearance was superior as well.

Meanwhile, Comparative Example 1 not including a zinc dialkyldithiophosphate had reduced moldability due to a high injection pressure. In addition, Comparative Example 2 including a long-chain fatty acid ester instead of a zinc dialkyldithiophosphate had enhanced moldability due to a reduced injection pressure, however, mechanical properties significantly deteriorated with Charpy impact strength, tensile strength, bending strength and bending modulus all decreasing.

The polyarylene sulfide resin composition of the present disclosure has excellent moldability, and has excellent mechanical properties such as strength and impact, and heat resistance as well, and accordingly, is capable of being used under a high temperature environment, and is thereby useful.

1. A polyarylene sulfide resin composition comprising:
a polyarylene sulfide; and
a zinc dialkyldithiophosphate.

2. The polyarylene sulfide resin composition of claim 1, wherein the zinc dialkyldithiophosphate comprises one or more alkyl groups having 5 to 20 carbon atoms per group.

3. The polyarylene sulfide resin composition of claim 1, wherein the zinc dialkyldithiophosphate is included in an amount of greater than or equal to 0.001 parts by mass and less than or equal to 20 parts by mass, with respect to 100 parts by mass of the polyarylene sulfide resin.

4. The polyarylene sulfide resin composition of claim 1, wherein the polyarylene sulfide is polyphenylene sulfide.

5. The polyarylene sulfide resin composition of claim 1, wherein the polyarylene sulfide is included in an amount of greater than or equal to 40% by mass and less than or equal to 99% by mass, of the polyarylene sulfide resin composition.

6. A method for enhancing moldability of a polyarylene sulfide resin, the method comprising:
adding a zinc dialkyldithiophosphate to the polyarylene sulfide resin.

7. The method of claim 6, wherein the zinc dialkyldithiophosphate comprises one or more alkyl groups having 5 to 20 carbon atoms per group.

8. The method of claim 6, wherein the zinc dialkyldithiophosphate is added in an amount of greater than or equal to 0.001 parts by mass and less than or equal to 20 parts by mass, with respect to 100 parts by mass of the polyarylene sulfide resin.

9. The method of claim 6, wherein the polyarylene sulfide is polyphenylene sulfide.
